(19) United States
(12) Patent Application Publication
(10) Pub. No.: US 2009/0067059 A1
(43) Pub. Date: Mar. 12, 2009

(54) DEVICE AND METHOD FOR ALTERING THE PATH OF MAGNETIC WAVES TO RECORD THE ACTIVITY THEREOF

(76) Inventors: William Patrick Crabtree, Portland, OR (US); Lance Thomas Haubrick, Concho, AZ (US)

Correspondence Address: CHRIS A. CASEIRO, VERRILL DANA, LLP, ONE PORTLAND SQUARE, PORTLAND, ME, 04112-0586, US

(21) Appl. No.: 11/853,650

(22) Filed: Sep. 11, 2007

(51) Int. Cl. G02B 27/00

(52) U.S. Cl. 359/642

(57) ABSTRACT

A device and related method for refracting magnetic waves to enable the temporary or permanent recording of said waves. The device includes a piece of material that is transparent or translucent to magnetic waves. The piece of material, which may be solid, is selected to have a magnetic refraction index greater than a value of one for either its transparent or translucent state. The magnetic waves are selectively passed through the material and recorded on a translation medium for observation.

### BACKGROUND OF THE INVENTION

1. Field of the Invention

The present invention relates to previously undiscovered independent magnetic waves and the spectrum which they comprise, specifically to the manipulation of these magnetic waves to obtain useful information about materials that they have reflected from, passed through, or originated from.

2. Description of the Prior Art

In 1864, James Clerk Maxwell published a paper that explained light as the propagation of electromagnetic waves. From this paper, Maxwell's equations were developed. Mr. Maxwell stated, “The agreement of the results seem to show that light and magnetism are affections of the same substance, and that light is an electromagnetic disturbance propagated through the field according to electromagnetic laws”.

Maxwell's equations have been scientifically verified repeatedly. As a result, the equations derived by James Maxwell are not disputable. The data interpreted by stating light to be a component of the electromagnetic spectrum can be alternately interpreted by stating that magnetic phenomena have wave components that behave in a manner identical to the behavior of light, but are not an integral part of light. That is, the magnetic waves and light waves are different energy frequency spectrums that can co-exist but are not inseparably bound.

Materials exist that are transparent or translucent to light and possess properties causing them to refract, reflect, absorb, or perform a combination of these actions on light waves. A logical derivative of the alternate interpretation is that materials that are transparent or translucent to magnetic waves and possess properties causing them to refract, reflect, absorb, or perform a combination of these actions on magnetic waves also must exist.

A second derivative is that due to the original interpretation of Maxwell's equations, a lack of sensory information relating to the immediate environment and the universe in general has been missing. Without the alternative interpretation the existence of magnetic waves is not obvious within consensus physics.

### SUMMARY OF THE INVENTION

The present invention is a device and related method for altering the path of magnetic waves existing in the magnetic spectrum so as to enable the temporary or permanent recording of said waves. The device includes a piece of material that is transparent or translucent to magnetic waves. The piece of material, which may be a single solid piece or formed of a plurality of pieces layered together, has two or more surface areas providing one or more entrances into and one or more exits from the material for the magnetic waves. The material is selected to have a magnetic refraction index greater than a value of one for either its transparent or translucent state.

The related method includes the step of selectively passing the magnetic waves through the material such that all magnetic wave frequencies are passed though the material for the transparent state, and less than all magnetic wave frequencies are passed through the material for the translucent state. The method further includes the step of directing the magnetic waves to a translation medium perceivable to a human observer. The medium, which may include, but not be limited to, photographic film, electronic instruments, or any other medium capable of capturing magnetic waves, is selected to enable the temporary or permanent recording of information about materials that they have reflected from, passed through, or originated from.

In accordance with one embodiment of the invention, the device for refracting magnetic waves comprising a solid piece of material with a refraction index greater than a value of one is shaped as a biconvex lens. Other embodiments are described and shown herein and the advantages of the invention will become more apparent upon review of the following detailed description, the accompanying drawings and the appended claims.

### BRIEF DESCRIPTION OF THE DRAWINGS

FIG. 1A shows the front or back view and FIG. 1B shows a side view perpendicular to the front and back sides of a magnegraphic lens, one embodiment of the magnegraphic device. FIG. 1C illustrates minimum thickness values.

FIG. 2A shows a front view of a lens disk with mounting tabs. FIG. 2B shows a front view of a lens disk with an encircling mounting rim.

FIG. 3A shows the front or back view and FIG. 3B shows a side view perpendicular to the front and back sides of a magnegraphic lens, one embodiment of the magnegraphic device.

FIG. 4A shows the front or back view and FIG. 4B shows the cross section view perpendicular to the front and back sides of a magnegraphic lens, one embodiment of the magnegraphic device.

FIG. 5A shows the front or back view and FIG. 5B shows the cross section view perpendicular to the front and back sides of a magnegraphic lens, one embodiment of the magnegraphic device.

FIG. 6 shows a perspective view of a magnegraphic prism, one embodiment of the magnegraphic device.

FIG. 7 shows a perspective view of a magnegraphic filter, one embodiment of the magnegraphic device.

FIG. 8 shows a simplified perspective representation of a magnegraphic lens of the present invention used in combination with a recording device and recording medium.

### DETAILED DESCRIPTION OF THE PREFERRED EMBODIMENTS OF THE INVENTION

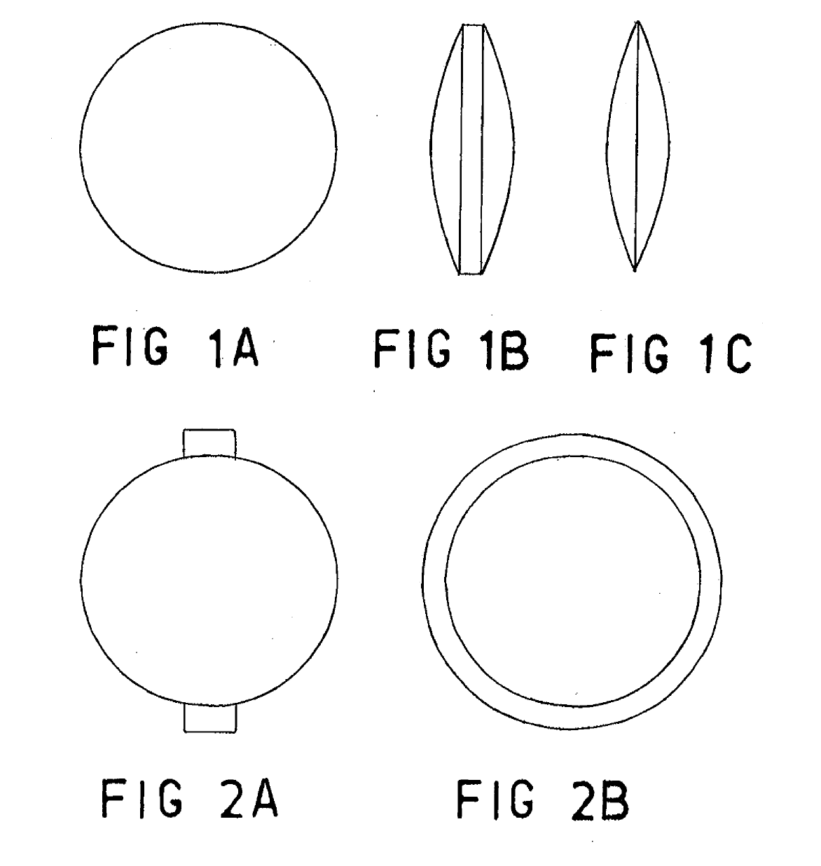

Bi-Convex Embodiment—FIGS. 1A and 1B

FIG. 1A shows the front or back view and FIG. 1B shows a side view perpendicular to the front and back sides of a first embodiment of a magnegraphic device of the present invention as a first magnegraphic lens configuration. This embodiment is a lens, convex on both sides, made from a single piece of material. The radius of curvature of each of its convex sides, its thickness, and its diameter, may be varied. The curvature may be adjusted to eliminate spherical aberration (not shown). This embodiment can be made of various materials, although metals and their alloys may be preferred.

The geometry of the magnegraphic lens shown is that of a circular disk (FIG. 1A). Many other geometries such as oval, triangle, square etc, may be used but will complicate the curving of the front or back sides, which may distort images, which distortion must be taken into account. The thickness of the lens at its center and rim can vary (FIG. 1B and FIG. 1C), but have minimum values imposed by its diameter and the radius of curvature selected for the curved surfaces.

The embodiment of the magnegraphic lens shown in FIGS. 1A-1C may be attached by screws, straps, clamps, or other attachment means or methods to a support structure suited to the application. A second related embodiment of the magnegraphic lens may also have tabs (FIG. 2A), or a single continuous protrusion (FIG. 2B) completely encircling the rim, to facilitate the use of screws, clamps, straps, etc. The inclusion of such means for attachment or other means of attachment to a suitable or desired support structure may be applied to all other embodiments of the magnegraphic lens as described herein.

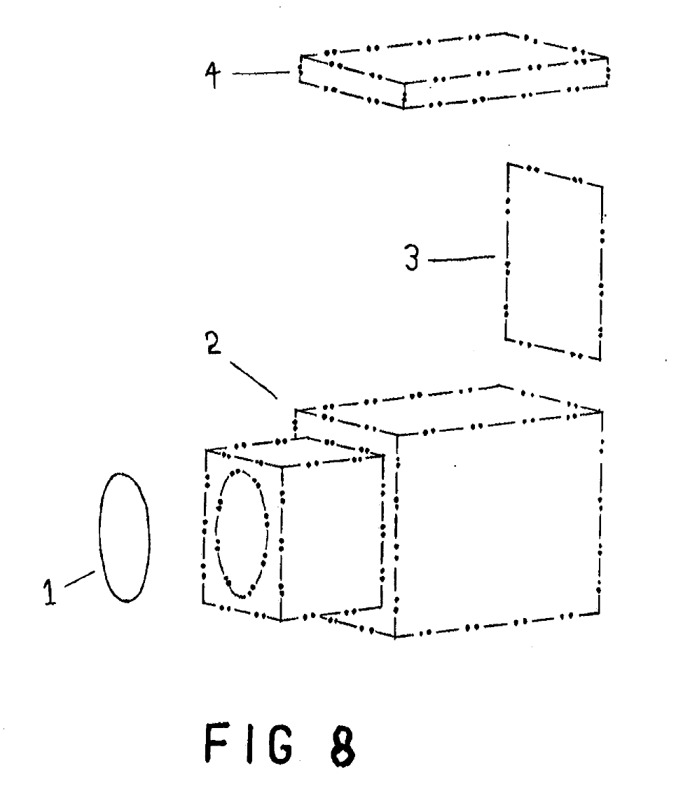

A functioning prototype of this embodiment (FIG. 8) has been constructed by taking a box camera and replacing the glass lens with an Aluminum alloy magnegraphic lens (1). The Aluminum Alloy used for the prototype was 6061-T6511, which was selected for hardness and its commercial availability. It is to be understood that other materials may be used to construct a magnegraphic device, provided they have a magnetic refractive index greater than one. The prototype lens (1) was polished to a mirror finish using well known metal polishing methods. The number of defects in the surfaces of the magnegraphic device were minimized as much as reasonably possible. The lens (1) was then coated with a polymer layer, which is only needed when a material selected to form the lens oxidizes easily. Therefore, a polymer layer may not always be required.

The support structure, a box (2) with a light-proof lid (4), was selected for its compatibility with the selected permanent recording medium, which was a sheet of black and white film (3). The film (3) used for the prototype was a Silver Halide film with high Silver content. More specifically, the film used as the recording medium was Efke EFPL50M4550 PL 50 M black and white film available from Freestyle Photographic Supplies of Hollywood, Calif. It is to be understood that other recording media and/or other support structures may be employed without deviating from the primary concept of the present invention, which is the use of a magnegraphic lens arranged to allow some or all magnetic waves to pass therethrough for recordation, permanent or temporary, on a recording medium.

### Bi-Convex Operation

An experiment was performed using the prototype to verify the concept embodied by the invention. In the course of developing the prototype for the purpose of recording on the medium, it was determined that pre-exposure of the film to diffuse light was an effective way to ensure that the magnetic waves generated by, reflecting from or passing through an object under observation would be viewable on the film after exposure to the magnetic waves passing through the lens.

This first embodiment of the invention operates by focusing magnetic waves in the same manner that a glass lens focuses light. The functioning prototype has focused images of the sun, power line transformers, and other objects radiating magnetic waves. The magnetic waves have an affect on the black and white film opposite to that of light; the film emulsion became more reactive to the developing chemical not less. In addition, if the film is exposed to diffuse light before hand, the magnetic waves focused by the magnegraphic lens negates the effect of the light. The magnegraphic image obtained is thus a positive image.

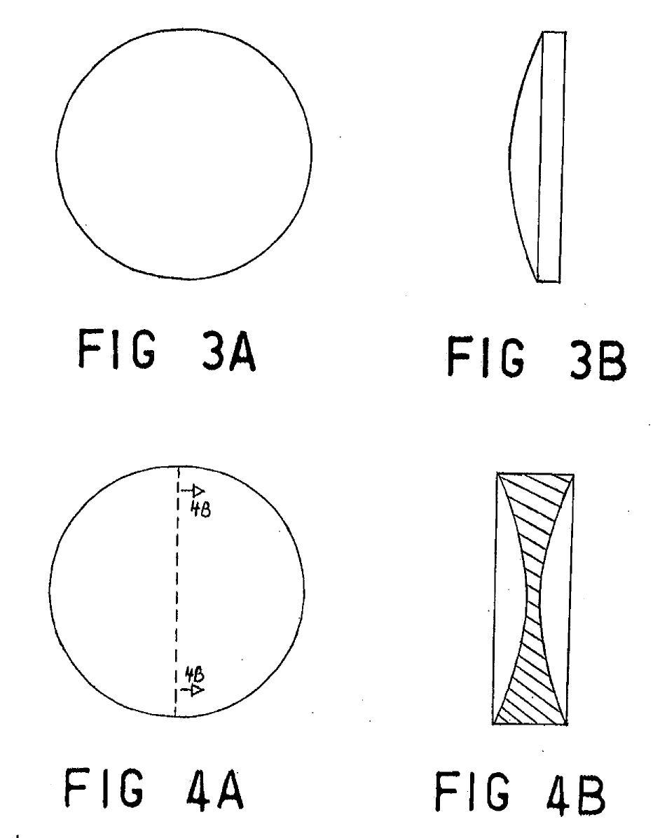

### Planar Convex Embodiment—FIGS. 3A and 3B

FIG. 3A shows the front or back view and FIG. 3B shows a side view perpendicular to the front and back sides of a second embodiment of the magnegraphic device as a second magnegraphic lens configuration. This embodiment is a lens, convex on one side and flat on the other side, made from a single piece of material. The radius of curvature of its convex side, its thickness, and its diameter, may be varied. The curvature may be adjusted to eliminate spherical aberration (not shown). This embodiment can be made of various materials, although metals and their alloys may be preferred. This embodiment may be attached by screws, straps, clamps, or other methods to a support structure suited to the application.

### Planar Convex Operation

This second embodiment of the invention causes the magnetic waves to converge, resulting in a focused image. Its magnetic focal length is longer than the bi-convex embodiment provided that the radius of curvature of the convex sides and material used are identical.

### Bi-Convex Embodiment—FIGS. 4A and 4B

FIG. 4A shows the front or back view and FIG. 4B shows the cross section view perpendicular to the front and back sides of a third embodiment of the magnegraphic device of the present invention as a third magnegraphic lens configuration. This embodiment is a lens, concave on both sides, made from a single piece of material. The radius of curvature of each of its concave sides, its thickness, and its diameter, may be varied. The curvature may be adjusted to eliminate spherical aberration (not shown). This embodiment can be made of various materials, although metals and their alloys may be preferred. This embodiment may be attached by screws, straps, clamps, or other methods to a support structure suited to the application.

### Bi-Concave Operation

This embodiment causes the magnetic waves to diverge.

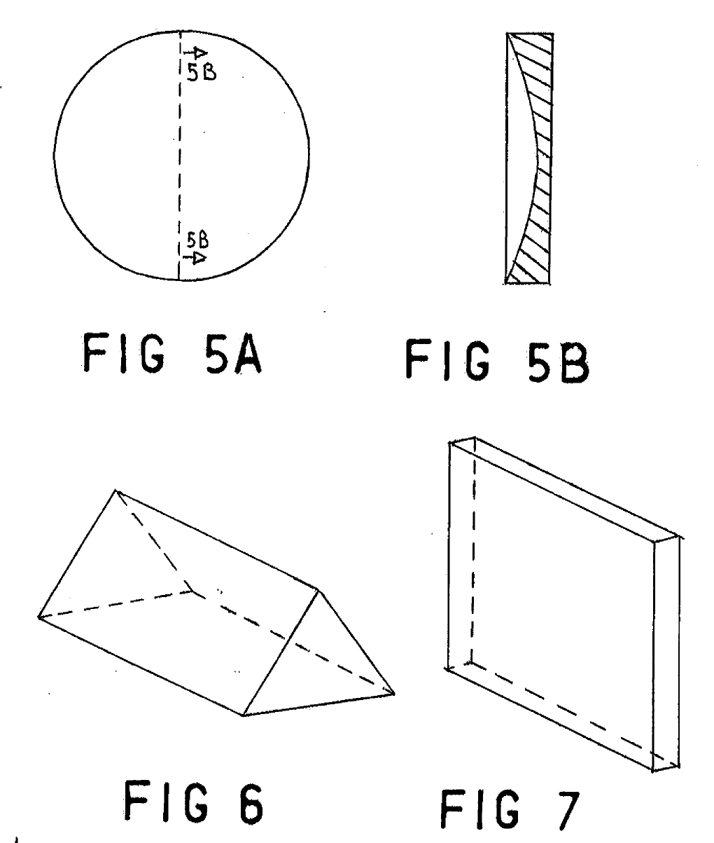

### Planar Concave Embodiment—FIGS. 5A and 5B

FIG. 5A shows the front or back view and FIG. 5B shows the cross section view perpendicular to the front and back sides of a fourth embodiment of the magnegraphic device of the present invention as a fourth magnegraphic lens configuration. This embodiment is a lens, concave on one side and flat on the other side, made from a single piece of material. The radius of curvature of its concave side, its thickness, and its diameter, may be varied. The curvature may be adjusted to eliminate spherical aberration (not shown). This embodiment can be made of various materials, although metals and their alloys may be preferred. This embodiment may be attached by screws, straps, clamps, or other methods to a support structure suited to the application.

### Planar Concave Operation

This embodiment causes the magnetic waves to diverge.

### Prism Embodiment—FIG. 6

FIG. 6 shows a perspective view of a fifth embodiment of the magnegraphic device of the present invention as a magnegraphic prism. This embodiment is a prism made from a single piece of material with three or more flat surfaces forming a triangle, rectangle, pentagon, etc in cross section with two ends which are flat and parallel to the plane of the cross section. Its length end to end, the angular relationship of the sides forming the cross section, and its greatest thickness may be varied. This embodiment can be made of various materials, although metals and their alloys may be preferred. This embodiment may be attached by screws, straps, clamps, or other methods to a support structure suited to the application.

### Prism Operation

This embodiment refracts a beam of magnetic waves unequally resulting in a display of the magnetic spectrum from lowest to highest frequency.

### Filter Embodiment—FIG. 7

FIG. 7 shows a perspective view of a sixth embodiment of the magnegraphic device of the present invention as a magnegraphic filter. This embodiment is a plate, made from a single piece of material with two flat parallel surfaces and may be formed as a square, circular, oval, etc plate. The dimensions of this embodiment can be varied. This embodiment may be attached by screws, straps, clamps, or other methods to a support structure suited to the application.

### Filter Operation

This embodiment significantly reflects or absorbs some but not all magnetic waves. It thus acts as a filter. The magnetic frequencies reflected or absorbed will be determined by the material which is selected.

### Advantages and Uses of the Magnegraphic Device

Some of the uses of the magnegraphic embodiments are described in the following descriptions.

1. Radio Astronomy

The magnegraphic lens embodiments can provide superior resolution with a single magnegraphic lens replacing an entire array of parabolic dishes. For example, a set of one or more magnegraphic lenses in the bi-convex configuration may be used to focus the magnetic waves radiating from stars onto a translation medium. In addition, an optional bi-concave lens could be used in combination with a bi-convex lens to eliminate chromatic distortions.

2. Medicine

The magnegraphic lens embodiments can provide a method of viewing the interior of the human body with a procedure as harmless as five minutes of exposure to direct sunlight. For example, a magnegraphic lens in the bi-convex configuration may be used to detect magnetic waves passing through the body to observe opacity variations indicative of conditions within the body, or magnetic waves reflecting from parts of the body, wherein the magnetic waves passing through or reflecting are focused onto the translation medium.

3. Geology

The magnegraphic lens embodiments can provide geologists with an additional tool for locating valuable deposits. For example, a set of one or more magnegraphic lenses in the bi-convex configuration may be used to focus magnetic waves reflected from the earth indicative of conditions below the surface, as different materials reflect magnetic waves differently. Such an arrangement may include the bi-convex lens or lenses in combination with one or more other lenses, such as the filter configuration or the hi-concave configuration.

4. Security

The magnegraphic lens embodiments can provide a method of viewing the contents of metal containers. For example, a set of one or more magnegraphic lenses in the bi-convex configuration may be used to focus magnetic waves passing through or blocked by materials within an otherwise visibly opaque structure, such as for use in observing what may be on the other side of a wall or within a container.

### Ramifications and Scope of Use of the Invention

Embodiments of this invention can be classed as passive devices, that is, they are not energized by electric charges or magnetic fields, etc in order to function. Other embodiments can be obtained by applying the principles of optics, which are passive devices affecting light, to obtain the desired affect on magnetic waves. Some examples are a meniscus convex embodiment, meniscus concave embodiment, Fresnel embodiment, and the like but are not limited thereto. Also an embodiment may be used in aggregate combination with another embodiment or in combination with other devices to form a useful aggregate device such as a magnetic wave telescope, magnetic wave microscope, etc.

A plurality of example embodiments to help illustrate the invention have been described. Nevertheless, it will be understood that various modifications may be made without departing from the spirit and scope of the invention. Accordingly, other embodiments are within the scope of the claims appended hereto.

What is claimed is:

1. A method for altering the path of magnetic waves existing in the magnetic spectrum so as to enable the temporary or permanent recording of said waves, the method comprising the steps of:
a) positioning a material that is transparent or translucent to said magnetic waves in the path of said magnetic waves, wherein said material has two or more surface areas providing at least one entrance into and at least one exit from said material for said magnetic waves, and wherein said material has a magnetic refraction index greater than a value of one for either said transparent or translucent states;
b) selectively passing said magnetic waves through said material; and
c) directing said magnetic waves through said material to a translation medium selected to enable the temporary or permanent recording of information associated with said magnetic waves.

2. The method as claimed in claim 1 wherein the step of selectively passing includes the step of selectively passing all magnetic wave frequencies through the transparent material.

3. The method as claimed in claim 1 wherein the step of selectively passing includes the step of selectively passing less than all magnetic wave frequencies through the translucent material.

4. The method as claimed in claim 1 wherein the material is a solid piece of material.

5. A device for altering the path of magnetic waves existing in the magnetic spectrum so as to enable the temporary or permanent recording of said waves comprising a material that is transparent or translucent to said magnetic waves and has a magnetic refraction index greater than a value of one for its transparent or translucent state.

6. The device as claimed in claim 5 wherein the material is a solid piece of material.

7. The device as claimed in claim 5 wherein the material is formed as a magnegraphic lens.

8. The device as claimed in claim 7 wherein the magnegraphic lens is in a bi-convex configuration.

9. The device as claimed in claim 7 wherein the magnegraphic lens is in a planar-convex configuration.

10. The device as claimed in claim 7 wherein the magnegraphic lens is in a bi-concave configuration.

11. The device as claimed in claim 7 wherein the magnegraphic lens is in a planar-concave configuration.

12. The device as claimed in claim 7 wherein the magnegraphic lens is in a prism configuration.

13. The device as claimed in claim 5 wherein the material is arranged as a filter configuration.

14. The device as claimed in claim 7 wherein the magnegraphic lens is used in combination with one or more devices.

15. The device as claimed in claim 5 comprising a plurality of magnegraphic lenses aggregated together in any combination of lens configurations selected from the group consisting of bi-convex, planar-convex, bi-concave, planar-concave, prism and filter.
